(19) United States
(12) Patent Application Publication
(10) Pub. No.: US 2016/0269390 A1
(43) Pub. Date: Sep. 15, 2016

(54) DISPLAY APPARATUS AND CONTROL METHOD FOR DISPLAY APPARATUS

(71) Applicant: Seiko Epson Corporation, Tokyo (JP)

(72) Inventors: Koji Endo, Sapporo-shi (JP); Nozomi Sato, Kitahiroshima-shi (JP)

(21) Appl. No.: 15/060,435

(22) Filed: Mar. 3, 2016

(30) Foreign Application Priority Data
Mar. 10, 2015 (JP) 2015-047047

(51) Int. Cl. H04L 29/06; G06F 3/0481

(52) U.S. Cl. CPC H04L 63/083; G06F 3/04812

(57) ABSTRACT

A display apparatus includes a display section configured to display an image on a display surface, a storing section configured to store a first code and login information for logging in to a remote terminal connected to a network, a detecting section configured to detect a position on the display surface pointed by a pointer, a code-input receiving section configured to receive an input of a second code on the basis of the detected position, and a login processing section configured to log in to the remote terminal via the network using the login information when the second code coincides with the first code.

The entire disclosure of Japanese Patent Application No. 2015-047047, filed Mar. 10, 2015 is expressly incorporated by reference herein.

### BACKGROUND

1. Technical Field

The present invention relates to remote login.

2. Related Art

According to a technique of remote desktop connection, it is possible to log in (i.e., remotely log in) to a computer in a remote location from a computer at user's hand via a network and operate a desktop environment and files of the computer in the remote location. JP-A-2010-226399 (Patent Literature 1) mentions that a projector connectable to a network performs display based on data received from a remote terminal. In a technique described in Patent Literature 1, a user performs login operation for logging in to a remote server from a cellular phone and the remote server performs authentication processing and permits the login. The cellular phone exchanges operation with the remote terminal via the remote server and requests data transfer to the projector.

A screen projected by the projector is often visually recognized by a plurality of people. Therefore, in a mechanism in which login information such as an ID and a password for logging in to the remote terminal is input using the screen, the login information is easily visually recognized by an outsider. According to the technique described in Patent Literature 1, since the login operation is performed from the cellular phone, the login information is less easily visually recognized by an outsider. However, in the technique described in Patent Literature 1, a device to which the login information is input has to be prepared separately from the projector.

### SUMMARY

An advantage of some aspects of the invention is to provide a technique for, when logging in to a remote terminal, concealing login information even if a device to which the login information is input is not prepared separately from a display apparatus.

A display apparatus according to an aspect of the invention includes: a display section configured to display an image on a display surface; a storing section configured to store a first code and login information for logging in to a remote terminal connected to a network; a detecting section configured to detect a position on the display surface pointed by a pointer; a code-input receiving section configured to receive an input of a second code on the basis of the detected position; and a login processing section configured to log in to the remote terminal via the network using the login information when the second code coincides with the first code.

In the aspect of the invention, the first code and the login information are stored in association with each other. When the input of the second code coinciding with the first code is received using the pointer, the remote terminal is logged in using the login information. Therefore, according to the aspect, when logging in to the remote terminal, it is possible to conceal the login information even if a device to which the login information is input is not prepared separately from the display apparatus.

In the aspect of the invention, the display apparatus may further include: a login-information-input receiving section configured to receive an input of the login information; and an issuing section configured to issue the first code. The storing section may store the issued first code and the login information, the input of which is received, in association with each other.

According to the aspect of the invention with this configuration, it is possible to store the login information, the input of which is received beforehand, and the issued first code in association with each other and log in to the remote terminal using the login information when the input of second code coinciding with the first code is received.

In the aspect of the invention, when the login-information-input receiving section receives the input of the login information, the login processing section may attempt login to the remote terminal using the login information, the input of which is received, and the issuing section may issue the first code when the login processing section succeeds in the attempt.

According to the aspect of the invention with this configuration, the first code is issued when an input of correct login information is received. Therefore, it is possible to reduce likelihood of a failure in login to the remote terminal due to an error of the login information.

In the aspect of the invention, the display apparatus may further include a Web server unit configured to realize the login-information-input receiving section and the issuing section.

According to the aspect of the invention with this configuration, a function of receiving the input of the login information and a function of issuing the first code are realized by the Web server unit. Therefore, it is possible to receive the input of the login information and issue the first code using a Web page.

In the aspect of the invention, the display apparatus may further include a transmitting section configured to transmit, after the login to the remote terminal, position information indicating the detected position to the remote terminal via the network.

According to the aspect of the invention with this configuration, it is possible to transmit, on condition that the login is successful, the position information for operating the remote terminal.

In the aspect of the invention, the first code may be invalidated after the remote terminal is logged in once.

According to the aspect of the invention with this configuration, since the first code is invalidated after the login is performed once, it is less likely that the first code leaks to an outsider and the remote terminal is fraudulently logged in.

In the aspect of the invention, the first code may be invalidated when a predetermined time elapses from a point in time when the first code is issued.

According to the aspect of the invention with this configuration, since the first code is invalidated when the predetermined time elapses from the point in time when the first code is issued, it is less likely that the first code leaks to an outsider and the remote terminal is fraudulently logged in.

A control method according to another aspect of the invention is a control method for a display apparatus that displays an image on a display surface, the control method including: storing a first code and login information for logging in to a remote terminal connected to a network; detecting a position on the display surface pointed by a pointer; receiving an input of a second code on the basis of the detected position; and logging in to the remote terminal via the network using the login information when the second code coincides with the first code.

In the aspect of the invention, the first code and the login information are stored in association with each other. When the input of the second code coinciding with the first code is received using the pointer, the remote terminal is logged in using the login information. Therefore, according to the aspect, when logging in to the remote terminal, it is possible to conceal the login information even if a device to which the login information is input is not prepared separately from the display apparatus.

### BRIEF DESCRIPTION OF THE DRAWINGS

The invention will be described with reference to the accompanying drawings, wherein like numbers reference like elements.

FIG. 1 is a diagram showing the overall configuration of a display system according to an embodiment of the invention.

FIG. 2 is a block diagram showing the functional configuration of a projector according to the embodiment.

FIG. 3 is a block diagram showing the hardware configuration of the projector according to the embodiment.

FIG. 4 is a sequence chart showing processing concerning prior registration of login information of the display system according to the embodiment.

FIG. 5 is an explanatory diagram of an example of account management according to the embodiment.

FIG. 6 is a sequence chart showing processing during login by the display system according to the embodiment.

FIG. 7 is a diagram showing an example of an RDP connection screen according to the embodiment.

FIGS. 8A and 8B are explanatory diagrams of processing after remote login according to the embodiment.

FIG. 9 is a diagram showing the overall configuration of a display system according to a second embodiment of the invention.

FIG. 10 is a block diagram showing the functional configuration of a projector according to the embodiment.

FIG. 11 is a sequence chart showing processing concerning prior registration of login information of the display system according to the embodiment.

### DESCRIPTION OF EXEMPLARY EMBODIMENTS

### First Embodiment

Embodiments of the invention are explained below with reference to the drawings.

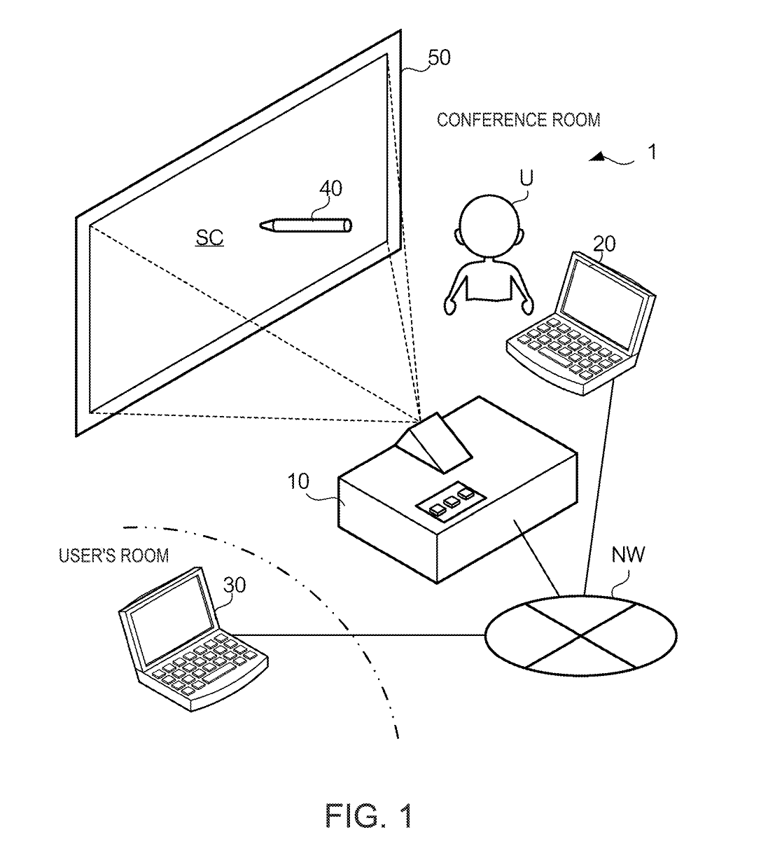

FIG. 1 is a diagram showing the overall configuration of a display system 1 according to a first embodiment of the invention. The display system 1 includes a projector 10, a client terminal 20, a remote terminal 30, and a pointer 40. A user U is a person who uses (owns) the client terminal 20 and the remote terminal 30. The projector 10, the client terminal 20, and the pointer 40 are disposed in a conference room where a conference is held. On the other hand, the remote terminal 30 is disposed in a room of the user U, which is a space separate from the conference room.

Note that, in FIG. 1, one client terminal 20 and one remote terminal 30 are shown. However, two or more client terminals 20 and two or more remote terminals 30 may be present.

The projector 10 is, for example, a liquid crystal projector and is a projection-type display apparatus that projects an image on a projection screen 50. The projector 10 projects a color image on the projection screen 50 on the basis of, for example, image signals corresponding to color components of the three primary colors of R (Red), G (Green), and B (Blue). The projection screen 50 is a reflection-type screen and is a projection surface on which an image (a video) is projected by the projector 10. A screen SC is displayed on the projection screen 50 by the projection. The projection surface is equivalent to a display surface on which an image is displayed.

The projector 10 has a function of logging in to the remote terminal 30 via a network NW on the basis of a technique of remote desktop (RDP) connection. The network NW is a LAN (Local Area Network). However, a communication system (standard) is not particularly limited and may be other networks (communication lines). The projector 10 may be connected to the network NW by either wireless or wired communication. A connection system is not particularly limited.

The client terminal 20 is a client terminal for the projector 10. The client terminal 20 is, for example, a general-purpose personal computer and is a terminal apparatus functioning as a signal source (a video source) of an image signal input to the projector 10. In this embodiment, the client terminal 20 outputs an image signal for displaying a presentation material including display elements such as characters, figures, and photographs. In this case, the user U is a person who performs a presentation referring to the presentation material projected by the projector 10. In this embodiment, the client terminal 20 is also used for prior registration of information for using the RDP connection besides being used as the signal source of the image signal input to the projector 10.

Note that the client terminal 20 may output an image signal for displaying an image other than the presentation material. The image displayed by the image signal is not limited to a still image and may be a moving image. The client terminal 20 may be connected to the network NW by either wireless or wired communication. A connection system is not particularly limited. The projector 10 may project an image on the basis of an image signal output from a video source apparatus such as a DVD player.

The remote terminal 30 is, for example, a general-purpose personal computer and is a terminal apparatus having a function of receiving login from an external apparatus such as the projector 10. The remote terminal 30 stores, for example, data concerning a material necessary for a conference. The remote terminal 30 may be connected to the network NW by either wireless or wired communication. A connection system is not particularly limited.

The pointer 40 is, for example, a pen-type device and is a pointer used by the user U in order to point a position on the projection screen 50. The pointer 40 is not limited to the pen type and may be an operation device having another shape such as a bar shape. The pointer 40 may be substituted with a pointer such as a hand or a finger of the user U.

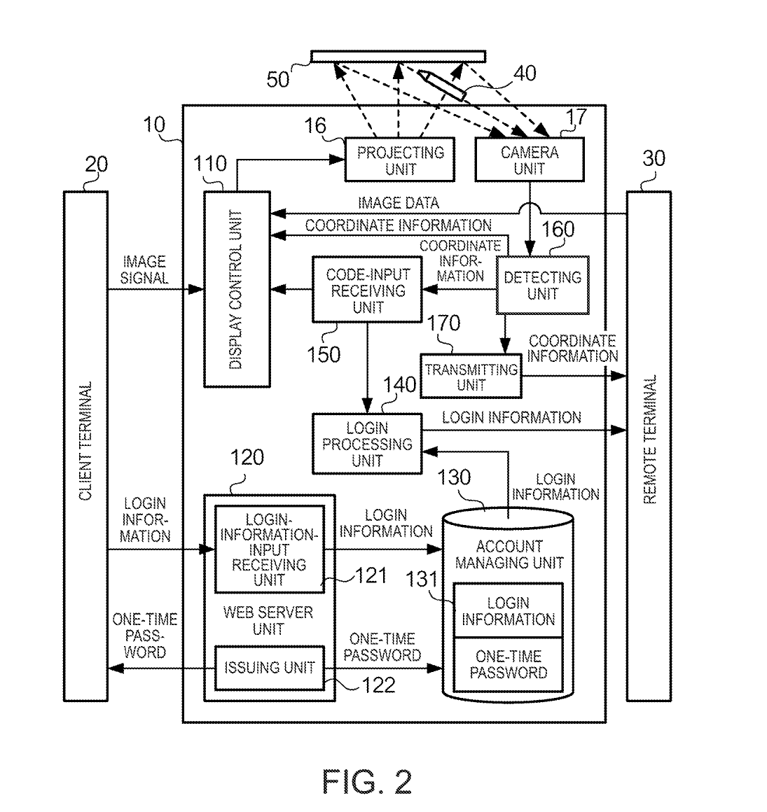

FIG. 2 is a block diagram showing the functional configuration of the projector 10. The projector 10 includes a display control unit 110, a Web server unit 120, an account managing unit 130, a login processing unit 140, a code-input receiving unit 150, a detecting unit 160, and a transmitting unit 170.

The display control unit 110 is a unit that performs control for displaying (i.e., projecting) an image on the projection screen 50. The display control unit 110 displays an image corresponding to an image signal input from the client terminal 20 on the projection screen 50. The display control unit 110 performs, on the basis of coordinate information indicating a position of the pointer 40 detected by the detecting unit 160, control for drawing an image (a line) corresponding to the pointed position. The display control unit 110 performs control for displaying a screen for receiving login operation for logging in to the remote terminal 30 (hereinafter referred to as “RDP connection screen”). After the login to the remote terminal 30, the display control unit 110 displays an image on the projection screen 50 on the basis of image data received from the remote terminal 30.

The Web server unit 120 is a server that controls display on a Web browser executed by the client terminal 20. The Web server unit 120 transmits screen data of an HTML (Hyper Text Markup Language) format to the client terminal 20.

The Web server unit 120 includes a login-information-input receiving unit 121 and an issuing unit 122. The login-information-input receiving unit 121 is a unit that receives an input of login information from the client terminal 20. The login information includes, for example, a login ID and a login password for logging in to the remote terminal 30. The login-information-input receiving unit 121 supplies the login information, the input of which is received, to the account managing unit 130. The issuing unit 122 is a unit that issues a one-time password as a first code. The issuing unit 122 supplies the issued one-time password to the client terminal 20 and the account managing unit 130.

The account managing unit 130 is a unit that manages an account for logging in to the remote terminal 30 via the projector 10. The account managing unit 130 includes an account-information storing unit 131 that stores information concerning the management of the account. The account-information storing unit 131 stores the login information, the input of which is received from the client terminal 20, and the one-time password issued to the client terminal 20 in association with each other.

The login processing unit 140 performs login processing, which is processing for logging in to the remote terminal 30 via the network NW. The projector 10 is connected to the remote terminal 30 via the network NW by the login and is capable of exchanging data related to remote desktop connection with the remote terminal 30.

The code-input receiving unit 150 receives, during the display of the RDP connection screen, an input of a one-time password serving as a second code on the basis of the coordinate information indicating the position of the pointer 40 detected by the detecting unit 160. When the one-time password (the second code), the input of which is received by the code-input receiving unit 150, coincides with the one-time password (the first code) stored in the account-information storing unit 131, the login processing unit 140 logs in (remotely logs in) to the remote terminal 30 using login information associated with the one-time password.

Further, the login processing unit 140 performs, using the login information, the input of which is received by the login-information-input receiving unit 121, a login test for attempting login to the remote terminal 30. When the login processing unit 140 has succeeded in the login test, the issuing unit 122 determines that the login information is correct and issues a one-time password.

The detecting unit 160 is a unit that detects a position on the projection screen 50 pointed by the pointer 40. The detecting unit 160 analyzes image pickup data representing a picked-up image of a camera unit 17, detects a position of the pointer 40 (e.g., a position of the distal end), and supplies coordinate information indicating a coordinate of the position.

The transmitting unit 170 is a unit that transmits, after the login to the remote terminal 30 by the login processing unit 140, coordinate information (equivalent to the position information according to the invention) indicating the position detected by the detecting unit 160 to the remote terminal 30 via the network NW. The transmitting unit 170 converts, on the basis of a coordinate conversion parameter, a coordinate system of the coordinate information calculated by the detecting unit 160 into a coordinate system of an image to be displayed by the remote terminal 30 and then transmits the converted coordinate information. The coordinate conversion parameter is a parameter representing a correspondence relation between a coordinate on the image and a coordinate in a region on the projection screen 50.

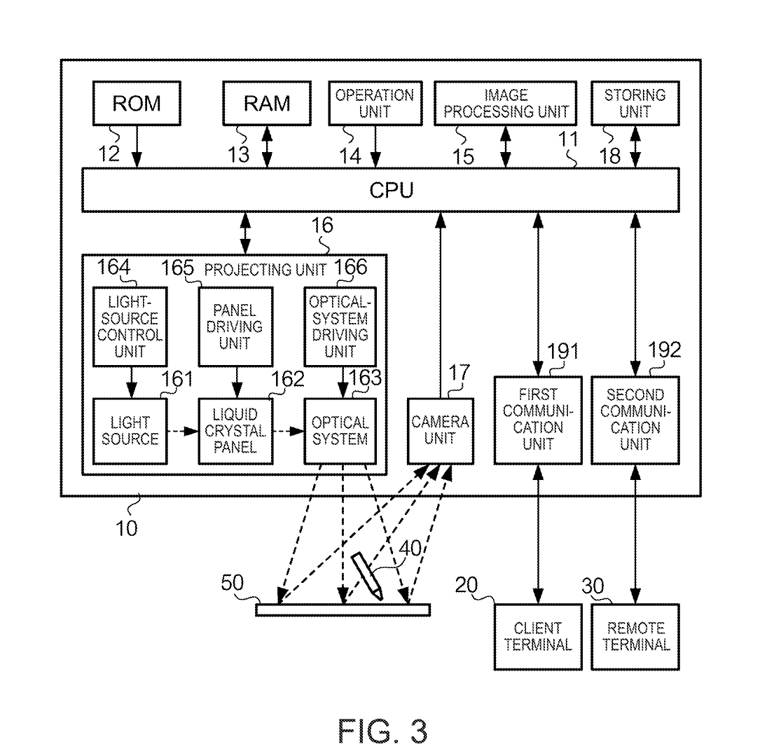

FIG. 3 is a block diagram showing the hardware configuration of the projector 10. As shown in FIG. 3, the projector 10 includes a CPU (Central Processing Unit) 11, a ROM (Read Only Memory) 12, a RAM (Random Access Memory) 13, an operation unit 14, an image processing unit 15, a projecting unit 16, a camera unit 17, a storing unit 18, a first communication unit 191, and a second communication unit 192.

The CPU 11 is a processor that reads out a computer program stored in a storing unit such as the ROM 12 to the RAM 13 and executes the computer program to thereby control the units of the projector 10. The operation unit 14 is operation means including an operator for performing various kinds of operation such as ON/OFF of a power supply of the projector 10.

The image processing unit 15 includes an image processing circuit such as an ASIC (Application Specific Integrated Circuit) and manages image processing performed by the projector 10. The image processing unit 15 performs, according to the control by the CPU 11, predetermined image processing such as resize processing or keystone correction on an input image signal and generates image information.

The projecting unit 16 projects an image on the projection screen 50 on the basis of the image information after the image processing by the image processing unit 15. The projecting unit 16 includes a light source 161, a liquid crystal panel 162, an optical system 163, a light-source control unit 164, a panel driving unit 165, and an optical-system driving unit 166. The light source unit 161 is, for example, a solid-state light source including an LED (Light Emitting Diode) or a semiconductor diode. The light source unit 161 emits light to the liquid crystal panel 162. The liquid crystal panel 162 is a light modulator that modulates the light made incident from the light source 161. The liquid crystal panel 162 is provided to correspond to the respective three primary colors of RGB. The optical system 163 includes, for example, a lens and a driving circuit for lens adjustment, expands the light (image light) modulated by the liquid crystal panel 162, and projects the light on the projection screen 50. The light-source control unit 164 drives the light source 161 according to the control by the CPU 11. The panel driving unit 165 drives the liquid crystal panel 162 on the basis of image information supplied from the CPU 11. The optical-system driving unit 166 drives the driving circuit of the optical system 163 according to the control by the CPU 11.

Note that, as the light modulator, a reflection-type liquid crystal panel may be adopted or a digital micro-mirror device (DMD) or the like may be adopted.

The camera unit 17 includes an image sensor (e.g., a CMOS sensor or a CCD sensor) and picks up an image of the projection screen 50. The pointer 40 repeatedly emits light at a predetermined interval. The CPU 11 detects, on the basis of the emitted light of the pointer 40, an image of which is picked up by the camera unit 17, a position on the projection screen 50 pointed by the pointer 40.

Note that the projector 10 may detect a position pointed by reflected light of the pointer 40 according to, for example, a method of detecting the position using a light curtain or the like. The projector 10 may detect a position indicated by the pointer 40 by recognizing the shape of the pointer 40 through pattern recognition or the like.

The storing unit 18 includes, for example, a nonvolatile semiconductor memory and stores various data. The first communication unit 191 includes, for example, a wireless communication circuit and an antenna and is connected to the client terminal 20 by wireless communication. The second communication unit 192 includes, for example, a wireless communication circuit and an antenna and is connected to the remote terminal 30 via the network NW.

An operation of this embodiment is explained. The operation of this embodiment is roughly divided into A: prior registration of login information and B: processing during login to the remote terminal.

### A: Prior Registration of Login Information

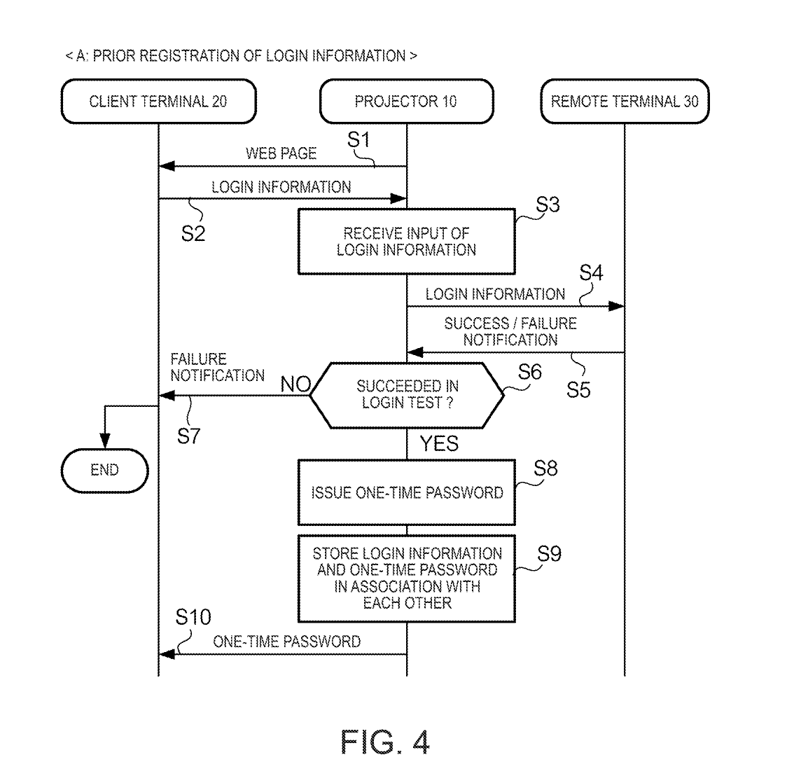

FIG. 4 is a sequence chart showing processing related to prior registration of login information of the projector 10.

It is assumed that the user U attempts to register login information of the remote terminal 30 in the projector 10 prior to the start of a presentation in a conference. In this case, the client terminal 20 accesses the projector 10 via the network NW according to operation by the user U. Therefore, the client terminal 20 does not need to be present in a conference room where the projector 10 is set and only has to be present under an environment in which the client terminal 20 can be connected to the network NW. The client terminal 20 accesses the Web server unit 120 of the projector 10 as explained below. Therefore, the client terminal 20 only has to be an apparatus implemented with at least a browser function. The client terminal 20 may be, for example, a smart phone. The power supply of the projector 10 may be always on. However, the projector 10 may operate in a power saving mode in a state in which at least an access from the client terminal 20 can be received.

When receiving an access from the client terminal 20, the CPU 11 of the projector 10 transmits a Web page for receiving an input of login information to the client terminal 20 via the first communication unit 191 (step S1). The client terminal 20 displays a screen of the received Web page and receives the input of the login information.

The client terminal 20 transmits the input login information to the projector 10 (step S2). The CPU 11 of the projector 10 receives the input of the login information via the first communication unit 191 (step S3).

Subsequently, the CPU 11 transmits the login information, the input of which is received in step S3, to the remote terminal 30 via the second communication unit 192 and performs a login test (step S4). The remote terminal 30 determines on the basis of the received login information whether to permit login. The remote terminal 30 transmits success notification to the projector 10 when the login information is correct and the CPU 11 has succeeded in the login and transmits a failure notification to the projector 10 when the CPU 11 has failed in the login because of an error of the login information (step S5).

Subsequently, the CPU 11 of the projector 10 determines whether the CPU 11 has succeeded in the login test (step S6). If determining that the CPU 11 has failed in the login test (NO in step S6), the CPU 11 transmits the failure notification to the client terminal 20 via the first communication unit 191 (step S7). In this case, the user U inputs correct login information again. The CPU 11 resumes the processing from step S3.

If determining that the CPU 11 has succeeded in the login test (YES in step S6), the CPU 11 issues a one-time password (a first code) (step S8). The CPU 11 issues the one-time password in step S8 at least not to overlap issued and effective other one-time passwords.

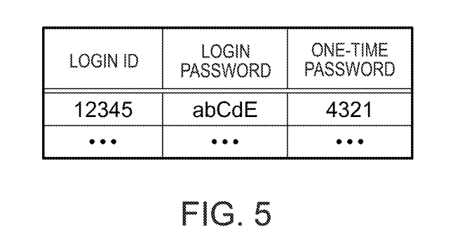

Subsequently, the CPU 11 causes the storing unit 18 to store the login information and the one-time password (the first code) in association with each other (step S9). As shown in FIG. 5, a login ID “12345” and a login password “abCdE” included in the login information and a one-time password “4321” are stored (registered) in association with each other.

Note that types of characters (including signs) and the numbers of characters respectively used in the login ID, the login password, and the one-time password are not particularly limited. However, the one-time password is desirably information that the user U can easily memorize.

Subsequently, the CPU 11 transmits the issued one-time password to the client terminal 20 via the first communication unit 191 (step S10). The client terminal 20 displays the received one-time password. The user U memorizes or writes down the displayed one-time password.

The processing related to the prior registration of the login information is as explained above. The processing related to the prior registration is carried out before a presentation, whereby it is possible to conceal the login information.

### B: Processing During Login to the Remote Terminal

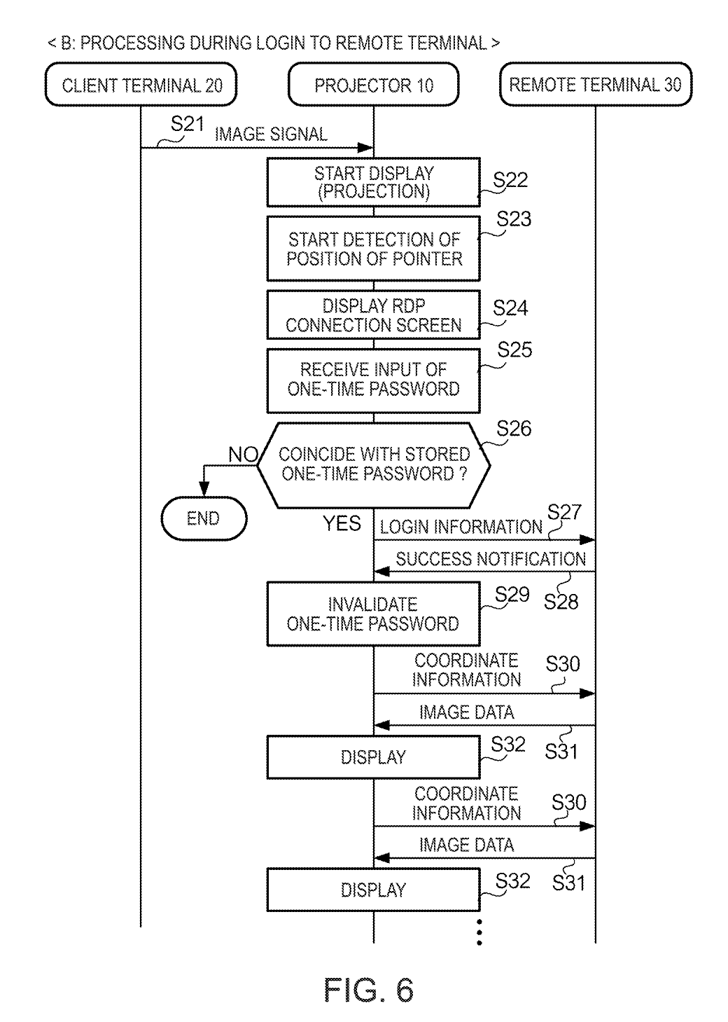

FIG. 6 is a sequence chart showing processing during login to the remote terminal 30 by the projector 10. The processing is performed, for example, when a necessary material is extracted from the remote terminal 30 while the user U is carrying out a presentation.

When an image signal is input from the client terminal 20 via the first communication unit 191 (step S21), the CPU 11 of the projector 10 controls the projecting unit 16 and starts display (projection) of an image on the projection screen 50 (step S22). Subsequently, the CPU 11 starts detection of a position on the projection screen 50 pointed by the pointer 40 (step S23). Thereafter, the CPU 11 repeatedly performs, for example, at a predetermined cycle, the detection of a position pointed on the projection screen 50.

When the user U instructs an access to the remote terminal 30 by, for example, operating a menu using the pointer 40, the CPU 11 of the projector 10 controls the projecting unit 16 to display an RDP connection screen on the projection screen 50 (step S24).

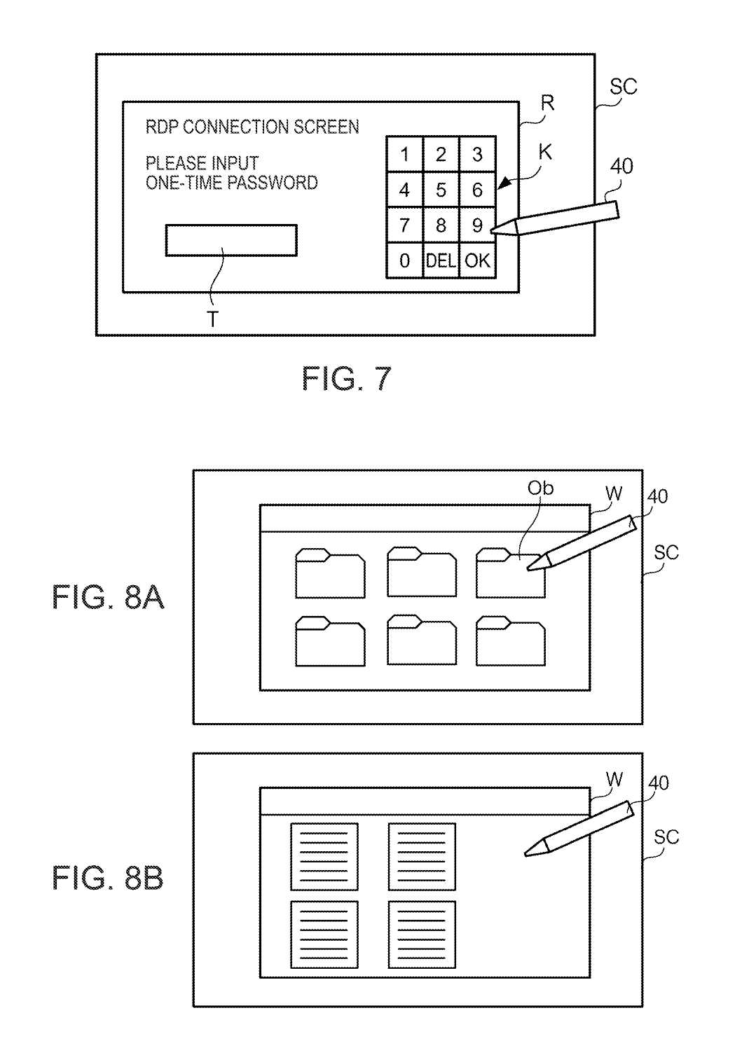

FIG. 7 is a diagram showing an example of the RDP connection screen. As shown in FIG. 7, an RDP connection screen R is displayed on a screen SC. On the RDP connection screen R, a message “please input a one-time password”, a display region T where input characters are displayed, and a key region K, on which number keys corresponding to numbers “0” to “9”, a “DEL” key for erasing the input characters, and an “OK” key for deciding the input are disposed, are displayed. The user U points a position of a key included in the key region K with the pointer 40 to thereby perform login operation for inputting a one-time password.

Referring back to FIG. 6, when receiving an input of a one-time password (a second code) on the basis of the detected position of the pointer 40 (step S25), the CPU 11 determines whether the one-time password coincides with the stored one-time password (first code) (step S26).

Note that a method of the input of the one-time password is not limited to operation for selecting the number keys. For example, the projector 10 may recognize characters (numbers) drawn on the projection screen 50 using the pointer 40 to thereby receive the input of the one-time password.

If determining that the one-time password does not coincide with the stored one-time password (NO in step S26), the CPU 11 displays indication to that effect on the projection screen 50. At this point, the CPU 11 may display the RDP connection screen R, which is explained with reference to FIG. 7, again in order to urge the user U to input a one-time password again.

If determining that the one-time password coincides with the stored one-time password (YES in step S26), the CPU 11 acquires the login information stored in association with the one-time password from the storing unit 18 and transmits the login information to the remote terminal 30 via the second communication unit 192 (step S27). For example, when receiving an input of the one-time password “4321”, the CPU 11 transmits the login information including the login ID “1234” and the login password “abCdE” to the remote terminal 30.

When the CPU 11 has succeeded in the login on the basis of the received login information, the remote terminal 30 transmits a success notification to the projector 10 (step S28). Consequently, the projector 10 changes to a state in which the projector 10 logs in to the remote terminal 30. Thereafter, the CPU 11 of the projector 10 displays, on the projection screen 50, a screen displayed in the remote terminal 30. Control for the display may be performed by a method same as normal remote desktop connection. For example, as shown in FIG. 8A, the CPU 11 displays a window W including objects respectively corresponding to a plurality of folders.

When succeeded in the login, the CPU 11 of the projector 10 invalidates the one-time password (the first code) used in the login (step S29). Processing for invalidating the one-time password is, for example, processing for deleting a set of the login information and the one-time password stored in the storing unit 18. However, the processing may be other processing for disabling the use of the one-time password, for example, deleting or rewriting a part of the one-time password.

After succeeded in the login, the CPU 11 repeatedly transmits coordinate information indicating a position on the projection screen 50 pointed by the pointer 40 to the remote terminal 30, for example, at a predetermined interval (step S30). The remote terminal 30 performs processing corresponding to the position indicated by the received coordinate information and transmits image data for displaying an image (a screen) corresponding to a result of the processing to the projector 10 (step S31). The CPU 11 displays the image corresponding to the received image data on the projection screen 50 (step S32). For example, when an object Ob corresponding to one folder is pointed by the pointer 40, as shown in FIG. 8B, the CPU 11 causes the projection screen 50 to display a list of files in the folder. In this way, the user U can point a position on the projection screen 50 using the pointer 40 and remotely operate the remote terminal 30.

Thereafter, the processing steps of steps S30 to S32 are repeatedly executed, for example, at a predetermined interval.

With the projector 10 in the first embodiment explained above, the one-time password and the login information stored beforehand are stored in association with each other. Thereafter, when an input of the same one-time password is received using the pointer 40, the remote terminal 30 is logged in using the login information. Therefore, with the projector 10, when logging in to the remote terminal 30, it is possible to remotely log in to the remote terminal 30 even if a device to which the login information is input, for example, a keyboard or a mouse, and various terminal devices are not prepared separately from accessories of the projector 10. As explained with reference to FIG. 7, the one-time password is sometimes displayed on the projection screen 50 but the login information is not displayed. Therefore, it is possible to conceal the login information. The one-time password is invalidated after being used once. Therefore, even if an outsider remembers the one-time password, the outsider cannot log in to the remote terminal 30. Therefore, security is improved.

The projector 10 performs prior registration of login information and issuance of a one-time password using a function of a Web server. Therefore, a screen for the prior registration is not projected on the projection screen 50 by the projector 10. In the prior registration, it is possible to conceal the login information. The user can perform the prior registration from a place different from a place where the projector 10 is set. Therefore, security is further improved.

Further, the projector 10 issues the one-time password when succeeded in a login test. Therefore, it is less likely that the projector 10 fails in login to the remote terminal 30 because of an error of the login information.

### Second Embodiment

A second embodiment of the invention is explained. In this embodiment, components denoted by reference numerals and signs same as the reference numerals and signs in the first embodiment realize functions same as the functions in the first embodiment. The second embodiment of the invention is explained below centering on differences from the first embodiment.

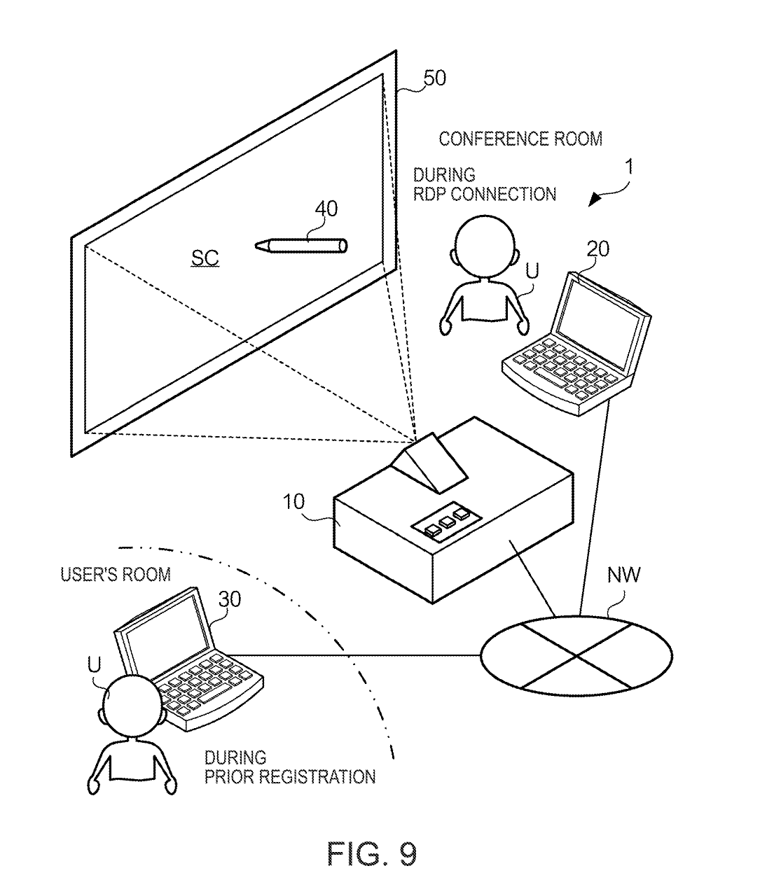

FIG. 9 is a diagram showing the overall configuration of the display system 1 according to the second embodiment of the invention. As in the first embodiment, the display system 1 includes the projector 10, the client terminal 20, the remote terminal 30, and the pointer 40. In the display system 1 in the first embodiment, the prior registration of the information for using the RDP connection is performed using the client terminal 20. On the other hand, in the display system 1 in this embodiment, the prior registration of the information for using the RDP connection is performed using the remote terminal instead of the client terminal 20. Therefore, when performing the prior registration of the information for using the RDP connection, the user U operates the remote terminal 30. When the RDP connection by the projector 10 is performed, the user U performs operation using the pointer 40. The client terminal 20 is used as a signal source of an image signal for the projector 10.

Note that the hardware configurations of the projector 10, the client terminal 20, the remote terminal 30, and the pointer 40 may be the same as the hardware configurations in the first embodiment.

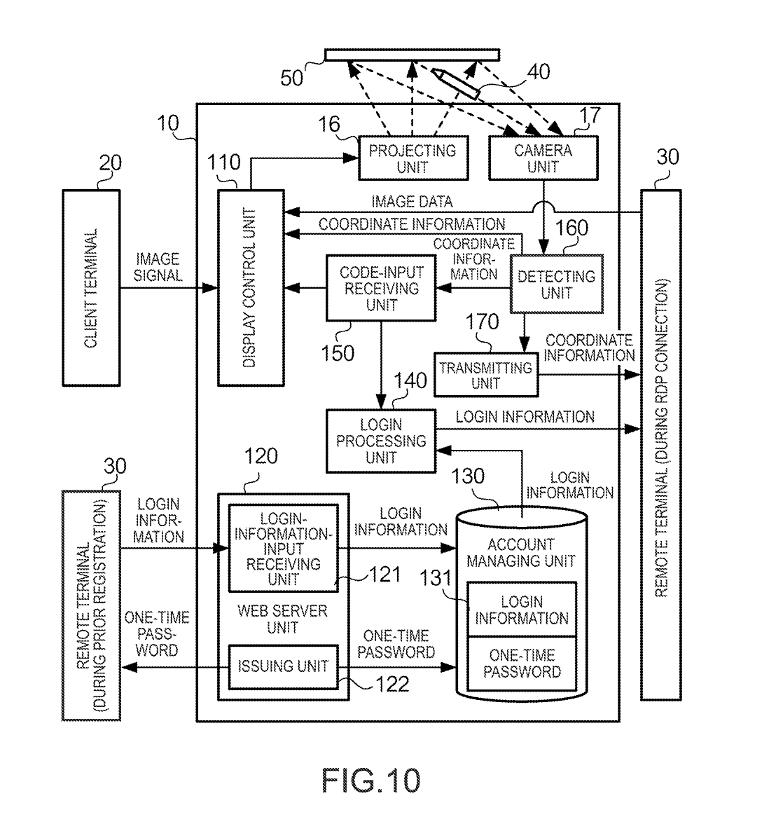

FIG. 10 is a block diagram showing the functional configuration of the projector 10 in this embodiment. As in the first embodiment, the projector 10 includes the display control unit 110, the Web server unit 120, the account managing unit 130, the login processing unit 140, the code-input receiving unit 150, the detecting unit 160, and the transmitting unit 170.

The Web server unit 120 in this embodiment is a server that controls display on a Web browser executed by the remote terminal 30. Therefore, the login-information-input receiving unit 121 receives an input of login information from the remote terminal 30. When issuing a one-time password as a first code, the issuing unit 122 supplies the issued one-time password to the remote terminal 30 and the account managing unit 130. The account-information storing unit 131 of the account managing unit 130 stores the login information, the input of which is received from the remote terminal 30, and the one-time password issued to the remote terminal 30 in association with each other.

Note that the other explanation concerning the functional configuration of the projector 10 is omitted because the explanation overlaps the explanation in the first embodiment.

An operation of this embodiment will be explained.

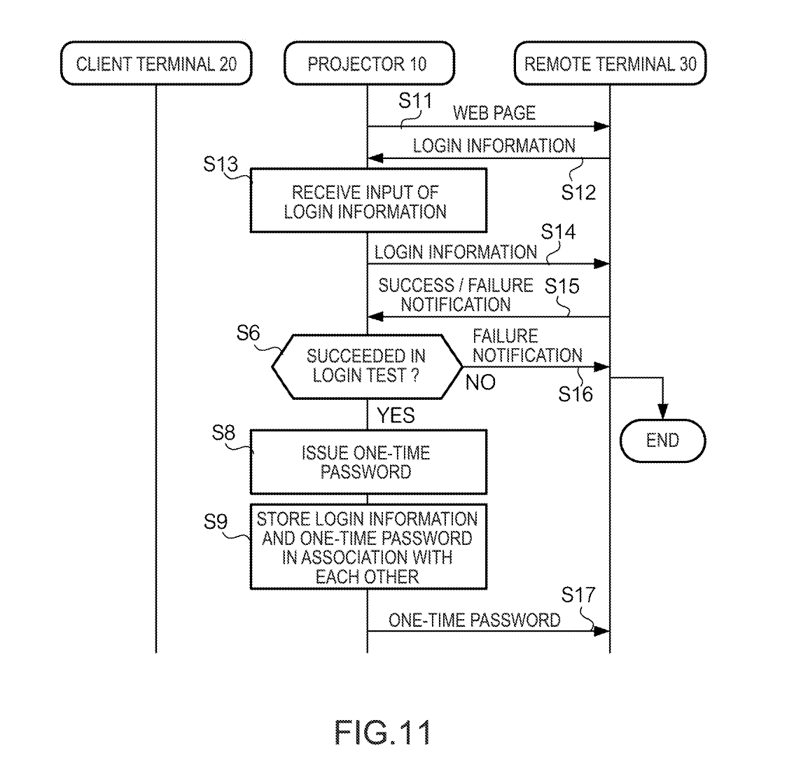

FIG. 11 is a sequence chart showing processing related to prior registration of login information of the projector 10 in this embodiment.

It is assumed that the user U attempts to register, using the remote terminal 30 operated by the user U, login information of the remote terminal 30 in the projector 10 prior to the start of a presentation in a conference. In this case, the remote terminal 30 accesses the projector 10 via the network NW according to the operation by the user U.

When receiving the access from the remote terminal 30, the CPU 11 of the projector 10 transmits a Web page for receiving an input of login information to the remote terminal 30 via the second communication unit 192 (step S11). The remote terminal 30 displays a screen of the received Web page and receives the input of the login information.

The remote terminal 30 transmits the input login information to the projector 10 (step S12). The CPU 11 of the projector 10 receives the input of the login information via the second communication unit 192 (step S13).

Subsequently, the CPU 11 transmits the login information, the input of which is received in step S13, to the remote terminal 30 via the second communication unit 192 and performs a login test (step S14). The remote terminal 30 transmits success notification to the projector 10 when the login information is correct and the CPU 11 has succeeded in the login and transmits a failure notification to the projector 10 when the CPU 11 has failed in the login because of an error of the login information (step S15). The CPU 11 of the projector 10 determines whether the CPU 11 has succeeded in the login test (step S6). If determining that the CPU 11 has failed in the login test (NO in step S6), the CPU 11 transmits the failure notification to the remote terminal 30 via the second communication unit 192 (step S16). If determining that the CPU 11 has succeeded in the login test (YES in step S6), the CPU 11 issues a one-time password (step S8).

Note that, in step S12, the remote terminal 30 may transmit the login information to the projector 10 on condition that it is determined that the login information, the input of which is received, is correct. In this case, the processing in steps S6 and S14 to S16 can be omitted. That is, the CPU 11 issues the one-time password in step S8 on condition that the input of the login information is received in step S13.

Subsequently, the CPU 11 causes the storing unit 18 to store the login information and the one-time password in association with each other (step S9). The CPU 11 transmits the issued one-time password to the remote terminal 30 via the second communication unit 192 (step S17). The remote terminal 30 displays the received one-time password. The user U memorizes or writes down the displayed one-time password.

The processing related to the prior registration of the login information is as explained above. Processing during login to the remote terminal 30 by the projector 10 may be the same as the processing explained with reference to FIG. 6 in the first embodiment. Therefore, explanation of the processing is omitted.

With the display system 1 in this embodiment, it is possible to perform the prior registration of the login information even if a device to which the login information is input is not prepared separately from accessories of the projector 10 and the remote terminal 30. Further, for example, the prior registration can be performed from a place where the remote terminal 30 is set such as a room of the user U. Therefore, efficiency is high and it is possible to conceal the login information.

### Modifications

The invention can be carried out in forms different from the embodiments explained above. Modifications explained below may be combined with one another as appropriate.

The projector 10 may use a code other than the one-time password. The projector 10 may invalidate the code, for example, when a predetermined time (e.g., 24 hours) elapses from a point in time when the code is issued. In a period in which the code is valid, the projector 10 may enable the code to be used a plurality of times. The projector 10 may invalidate the code after the code is used once. In this case, it is less likely that the code leaks to an outsider and the remote terminal 30 is fraudulently logged in. The projector 10 does not have to perform the processing for invalidating the code, for example, when a risk of a leak of the code and a risk in the case of the leakage are less. In this way, the code issued by the projector 10 only has to be at least information (typically, characters) associated with login information and different from the login information.

The projector 10 does not have to include the Web server 120. For example, the functions of the login-information-input receiving unit 121 and the issuing unit 122 may be realized by a function of an application program running on the client terminal 20 or the remote terminal 30.

A part of the configuration or the operation of the projector 10 in the embodiments explained above may be omitted. The projector 10 does not have to include, for example, a component related to the login test.

The display system 1 may be configured to enable the prior registration of the information for using the RDP connection to be performed from both of the remote terminal 30 and the client terminal 20 or may be configured to enable the prior registration to be performed from other apparatuses.

The display apparatus according to the invention is not limited to the projection-type display apparatus (the projector). The display apparatus according to the invention may be, for example, a monitor direct-view type display apparatus that adopts a touch screen. The display apparatus of this modification includes a display surface on which an image is displayed and a touch screen provided over the display surface. The display apparatus detects a position pointed on the display surface using the touch screen. The invention is particularly effective for concealing login information in a display apparatus that displays an image visually recognized by a plurality of people.

The functions realized by the projector 10 can be realized by a combination of a plurality of computer programs and can be realized by cooperation of a plurality of hardware resources. When the functions of the projector 10 are realized using a computer program, the computer program may be provided in a state in which the computer program is stored in a computer-readable recording medium such as a magnetic recording medium (a magnetic tape, a magnetic disk (an HDD (Hard Disk Drive) or an FD (Flexible Disk)), etc.), an optical recording medium (an optical disk, etc.), a magneto-optical recording medium, or a semiconductor memory or may be distributed via a network. The invention can also be grasped as a control method for the display apparatus.

What is claimed is:

1. A display apparatus comprising:
a display section configured to display an image on a display surface;
a storing section configured to store a first code and login information for logging in to a remote terminal connected to a network;
a detecting section configured to detect a position on the display surface pointed by a pointer;
a code-input receiving section configured to receive an input of a second code on the basis of the detected position; and
a login processing section configured to log in to the remote terminal via the network using the login information when the second code coincides with the first code.

2. The display apparatus according to claim 1, further comprising:
a login-information-input receiving section configured to receive an input of the login information; and
an issuing section configured to issue the first code, wherein
the storing section stores the issued first code and the login information, the input of which is received, in association with each other.

3. The display apparatus according to claim 2, wherein
when the login-information-input receiving section receives the input of the login information, the login processing section attempts login to the remote terminal using the login information, the input of which is received, and
the issuing section issues the first code when the login processing section succeeds in the attempt.

4. The display apparatus according to claim 2, further comprising a Web server unit configured to realize the login-information-input receiving section and the issuing section.

5. The display apparatus according to claim 1, further comprising a transmitting section configured to transmit, after the login to the remote terminal, position information indicating the detected position to the remote terminal via the network.

6. The display apparatus according to claim 1, wherein the first code is invalidated after the remote terminal is logged in once.

7. The display apparatus according to claim 1, wherein the first code is invalidated when a predetermined time elapses from a point in time when the first code is issued.

8. A control method for a display apparatus that displays an image on a display surface, the control method comprising:
storing a first code and login information for logging in to a remote terminal connected to a network;
detecting a position on the display surface pointed by a pointer;
receiving an input of a second code on the basis of the detected position; and
logging in to the remote terminal via the network using the login information when the second code coincides with the first code.
